(19) United States
(12) Patent Application Publication
(10) Pub. No.: US 2013/0183652 A1
(43) Pub. Date: Jul. 18, 2013

(54) METHOD AND SYSTEM FOR PROVIDING SETS OF USER COMMENTS AS ANSWERS TO A QUESTION

(71) Applicant: Vidit JAIN, Bangalore (IN)

(72) Inventor: Vidit JAIN, Bangalore (IN)

(73) Assignee: YAHOO! INC., Sunnyvale, CA (US)

(21) Appl. No.: 13/352,651

(22) Filed: Jan. 18, 2012

(51) Int. Cl. G09B 7/00

(52) U.S. Cl. 434/352

(57) ABSTRACT

A computer-implemented method of providing sets of user comments as answers to a question includes receiving a question from a user. The question includes information posted by the user on a website. The computer-implemented method also includes constructing a query from the question. Further, the computer-implemented method includes analyzing the query. Furthermore, the computer-implemented method includes extracting the sets of user comments related to the question from a database. Moreover, the computer-implemented method includes rendering the sets of user comments as answers to the question.

### TECHNICAL FIELD

Embodiments of the disclosure relate generally, to searching techniques and more specifically, to provide sets of user comments as answers to a question in a website.

### BACKGROUND

Users desire to fetch information on specific topics using Internet has enhanced. One of existing techniques to fetch information involves a question-and-answer method offered by a number of websites. For example, Yahoo! Answers allows the users to ask questions on any specific topic. Similarly, the users are also allowed to answer questions posted by other users. The answers to the questions further become a useful source of information to satisfy needs of different users. Consequently, a lot of knowledge is shared by the question-and-answer method.

However, the websites attract a relatively less number of the users to answer the questions posted on the websites. As a result, several of the questions receive few and unreliable answers. At times, only a single answer is received for a question which is unreliable. The scenario worsens when the questions remain unanswered. Often, the users are not engaged and entertained well. Subsequently, the users spend less time on the websites which in turn results in reduction of revenue.

In light of the foregoing discussion, there is a need for an efficient method and system for providing sets of user comments as answers to a question.

### SUMMARY

The above-mentioned needs are met by a computer-implemented method, system, and computer program product for providing sets of user comments as answers to a question.

An example of a computer-implemented method for providing sets of user comments as answers to a question includes receiving the question from a user, the question includes information posted by the user on a website. The computer-implemented method also includes constructing a query from the question. Further, the computer-implemented method includes analyzing the query. Furthermore, the computer-implemented method includes extracting sets of user comments related to the question from a database. Moreover, the computer-implemented method includes rendering the sets of user comments to the user, wherein the sets of user comments are answers to the question.

An example of a computer program product stored on a non-transitory computer-readable medium that when executed by a processor, performs a method for providing sets of user comments as answers to a question includes receiving the question from a user, the question includes information posted by the user on a website. The computer program product also includes constructing a query from the question. Further, the computer program product includes analyzing the query. Furthermore, the computer program product includes extracting the sets of user comments related to the question from a database. Moreover, the computer program product includes rendering the sets of user comments to the user, wherein the sets of user comments are answers to the question.

An example of a system for providing sets of user comments as answers to a question includes a web interface that receives a question posted by a user on a website. The system also includes a query engine that constructs a query from the question. Further, the system includes a database, communicatively coupled to the web interface. The database stores one or more user comments posted on one or more websites. Moreover, the system includes a retrieval engine that extracts sets of user comments related to the question from the database.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a flow diagram illustrating a method of providing sets of user comments as answers to a question, in accordance with one embodiment;

FIG. 2 is a block diagram illustrating a system for providing sets of user comments as answers to a question, in accordance with one embodiment;

FIG. 3 is a block diagram illustrating an exemplary computing device, in accordance with one embodiment; and

FIG. 4 is a block diagram illustrating an exemplary query engine, in accordance with one embodiment.

### DETAILED DESCRIPTION OF THE EMBODIMENTS

A computer-implemented method, system, and computer program product for providing sets of user comments as answers to a question is disclosed. The following detailed description is intended to provide example implementations to one of ordinary skill in the art, and is not intended to limit the invention to the explicit disclosure, as one or ordinary skill in the art will understand that variations can be substituted that are within the scope of the invention as described.

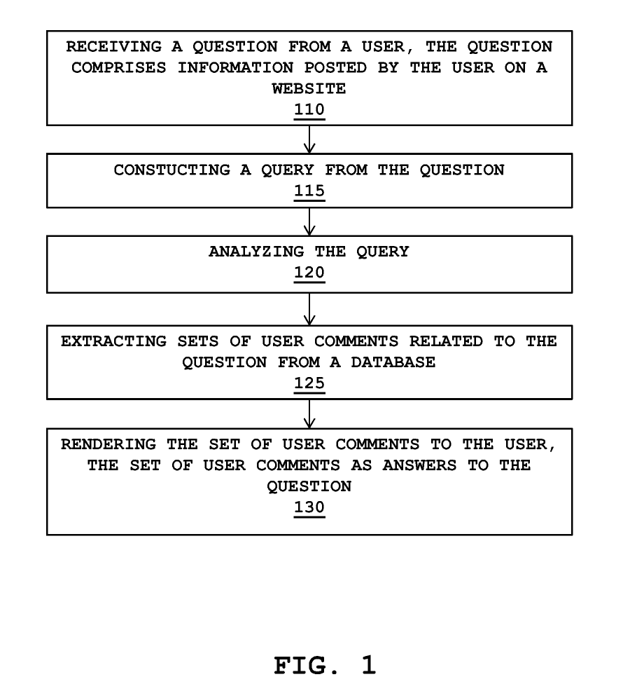

FIG. 1 is a flow diagram illustrating a method of providing sets of user comments as answers to a question, in accordance with one embodiment.

At step 110, a question is received from a user. The question includes information posted by the user on a website.

Occasionally, the user desires for more information on a topic. Consequently, the user browses Internet and posts the question related to the topic on the website, for example Yahoo! Answers.

The question includes information related to the topic. Further, the information can be of a discussion oriented type or an information seeking type. An example of the discussion oriented type includes, but is not limited to, “Reagan spent 2.2 trillion and a lot came out of it, Obama spent over 4 trillion and what has come out of it?”. Similarly, an example of the information seeking type includes, but is not limited to, “What does long term on job training mean?”.

At step 115, a query is constructed from the question.

Based on the question posted by the user, a query is constructed. The query is constructed based on contextual analysis and user preferences.

The contextual analysis includes identifying a plurality of entities and correlated responses of the user. The entities include named entities and related entities. Examples of the named entities include, but are not limited to, names of persons, organizations, locations, expressions of time, and quantities. Similarly, examples of the related entities include, but are not limited to, entities that share a common feature. Further, correlated responses of the user are defined as specific preferences of the user observed in the past. For example, the user prefers more information on global warming.

The user preferences refer to the topics that the user has previously posted questions.

The query is constructed by using the identified entities. For example, consider the user posts the question as “Reagan spent 2.2 trillion and a lot came out of it, Obama spent over 4 trillion and what has come out of it?”. The named entities are identified as Reagan, Obama, compare and budget. Similarly, the related entities are also identified as spent and trillion. The named entities and related entities thus identified are then used to construct the query. For example, the query is constructed as “compare+Reagan+Obama+budget+spending”.

At step 120, the query is analyzed.

The query is analyzed to identify the query as an information seeking query (for example, what do people think of X) or a discussion oriented query (for example, X versus Y). The information seeking query is a query that requires more information on a query topic. The discussion oriented query is a query that requires a plurality of user comments on the query topic.

Based on the identification, the query is categorized as one of the information seeking query or the discussion oriented query.

For example, consider the query “compare+Reagan+Obama+budget+spending”. The query is analyzed and further identified as the discussion oriented query.

At step 125, sets of user comments related to the question are extracted from a database.

The database accumulates the user comments posted by the users on one or more websites. In one embodiment, the user comments are organized based on topics.

The database is queried with the query to extract a plurality of user comments related to the topic. For example, on querying the database with the query “compare+Reagan+Obama+budget+spending”, the user comments that discuss spending during different governments in USA are retrieved. The user comments can also include other related discussions on comparing monetary policies of Reagan's and Obama's administrations.

Further, an appropriate index of the user comments is selected from the database.

At step 130, the sets of user comments are rendered to the user. The sets of user comments are answers to the question.

The sets of user comments provide more information on the topic entered in the question. In a different scenario, the sets of user comments provide answers to the question.

The plurality of user comments are further filtered from the selected index to obtain the most relevant user comments to suffice to the user requirements.

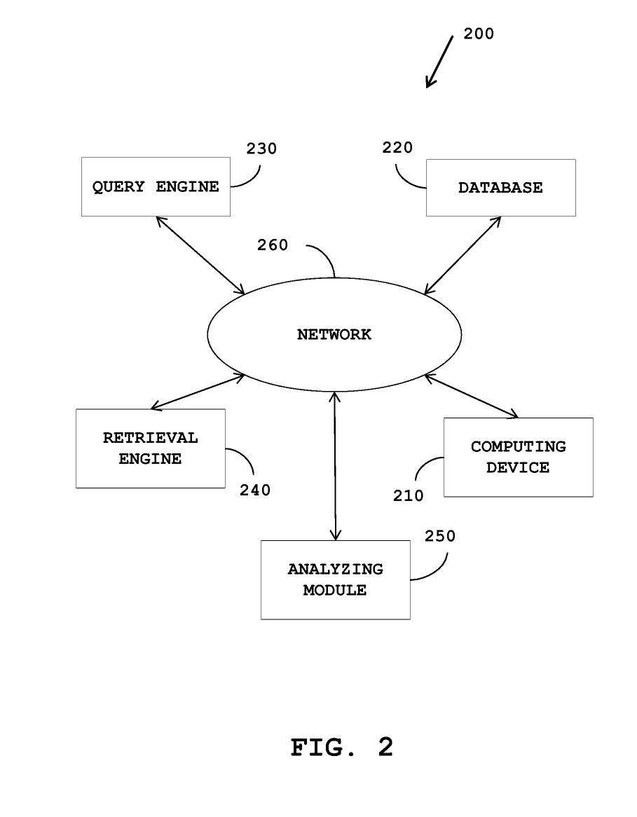

FIG. 2 is a block diagram illustrating a system for providing sets of user comments as answers to a question, in accordance with one embodiment.

The system 200 can implement methods described above. The system 200 includes a computing device 210, a database 220, a query engine 230, a retrieval engine 240 and an analyzing module 250 in communication with a network 260 (for example, the Internet or a cellular network).

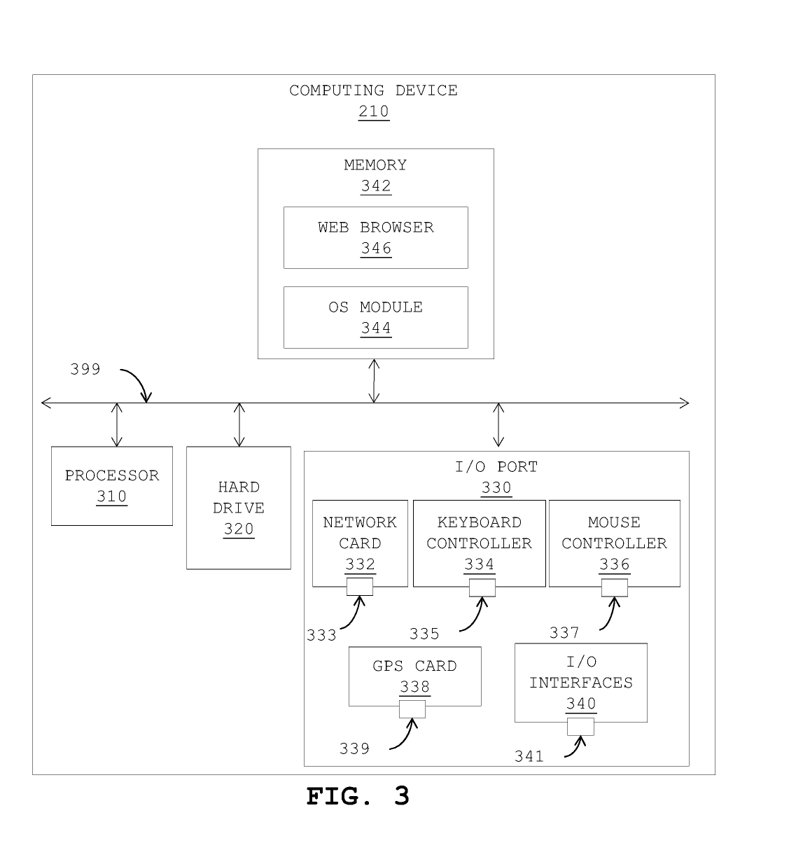

Examples of the computing device 210 include, but are not limited to, a Personal Computer(PC), a stationary computing device, a laptop or notebook computer, a tablet computer, a smart phone or Personal Digital Assistant (PDA), a smart appliance, a video gaming console, an Internet television, a set-top box, or other suitable processor-based devices that can send and view online video advertisements. In one embodiment, the computing device 210 displays a set of user comments as answers to a user comment. Additional embodiments of the computing device 210 are described in detail in conjunction with FIG. 3.

The database 220 accumulates and stores user comments posted on a plurality of websites.

The query engine 230 identifies important keywords and terms to construct a query in response to receiving a question posted by a user on a website. On constructing the query, the query engine 230 categorizes the query as a discussion oriented query or as an information seeking query. Further, the query engine 230 sends the query to the retrieval engine 240.

The retrieval engine 240 receives the query from the query engine 230. The retrieval engine 240 queries the database 220 using the query. On querying the database 220, sets of user comments that are relevant to the question are retrieved.

The analyzing module 250 identifies the query as either an information seeking query or as a discussion oriented query.

In one embodiment, the computing device 210 receives a question posted by a user on a website (for example, Yahoo! Answers). The question is entered by the user through a web interface. The web interface sends the question to the query engine 230. The query engine 230 constructs a query from the question and sends the query to the retrieval engine 240. The query is then used by the retrieval engine 240 to query the database 220 to retrieve sets of user comments. The sets of user comments are further filtered to provide relevant user comments as answers to the question. The web interface now displays the set of user comments as answers to the question posted by the user. Consequently, the user is provided with more information related to the question.

In some embodiments, the query engine 230, the retrieval engine 240 and the analyzing module 250 can be located in the computing device 210.

FIG. 3 is a block diagram illustrating an exemplary computing device, for example the computing device 210, in accordance with one embodiment. The computing device 210 includes a processor 310, a hard drive 320, an I/O port 330, and a memory 342, coupled by a bus 399.

The bus 399 can be soldered to one or more motherboards. Examples of the processor 310 includes, but is not limited to, a general purpose processor, an application-specific integrated circuit (ASIC), an FPGA (Field Programmable Gate Array), a RISC (Reduced Instruction Set Controller) processor, or an integrated circuit. The processor 310 can be a single core or a multiple core processor. In one embodiment, the processor 310 is specially suited for processing demands of location-aware reminders (for example, custom micro-code, and instruction fetching, pipelining or cache sizes). The processor 310 can be disposed on silicon or any other suitable material. In operation, the processor 310 can receive and execute instructions and data stored in the memory 342 or the hard drive 320. The hard drive 320 can be a platter-based storage device, a flash drive, an external drive, a persistent memory device, or other types of memory.

The hard drive 320 provides persistent (long term) storage for instructions and data. The I/O port 330 is an input/output panel including a network card 332 with an interface 333 along with a keyboard controller 334, a mouse controller 336, a GPS card 338 and I/O interfaces 340. The network card 332 can be, for example, a wired networking card (for example, a USB card, or an IEEE 802.3 card), a wireless networking card (for example, an IEEE 802.11 card, or a Bluetooth card), and a cellular networking card (for example, a 3G card). The interface 333 is configured according to networking compatibility. For example, a wired networking card includes a physical port to plug in a cord, and a wireless networking card includes an antennae. The network card 332 provides access to a communication channel on a network. The keyboard controller 334 can be coupled to a physical port 335 (for example PS/2 or USB port) for connecting a keyboard. The keyboard can be a standard alphanumeric keyboard with 101 or 104 keys (including, but not limited to, alphabetic, numerical and punctuation keys, a space bar, modifier keys), a laptop or notebook keyboard, a thumb-sized keyboard, a virtual keyboard, or the like. The mouse controller 336 can also be coupled to a physical port 337 (for example, mouse or USB port). The GPS card 338 provides communication to GPS satellites operating in space to receive location data. An antenna 339 provides radio communications (or alternatively, a data port can receive location information from a peripheral device). The I/O interfaces 340 are web interfaces and are coupled to a physical port 341.

The memory 342 can be a RAM (Random Access Memory), a flash memory, a non-persistent memory device, or other devices capable of storing program instructions being executed. The memory 342 comprises an Operating System (OS) module 344 along with a web browser 346. In other embodiments, the memory 342 comprises a calendar application that manages a plurality of appointments. The OS module 344 can be one of Microsoft Windows® family of operating systems (for example, Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64.

The web browser 346 can be a desktop web browser (for example, Internet Explorer, Mozilla, or Chrome), a mobile browser, or a web viewer built integrated into an application program. In an embodiment, a user accesses a system on the World Wide Web (WWW) through a network such as the Internet. The web browser 346 is used to download the web pages or other content in various formats including HTML, XML, text, PDF, and postscript, and may be used to upload information to other parts of the system. The web browser may use URLs (Uniform Resource Locators) to identify resources on the web and HTTP (Hypertext Transfer Protocol) in transferring files to the web.

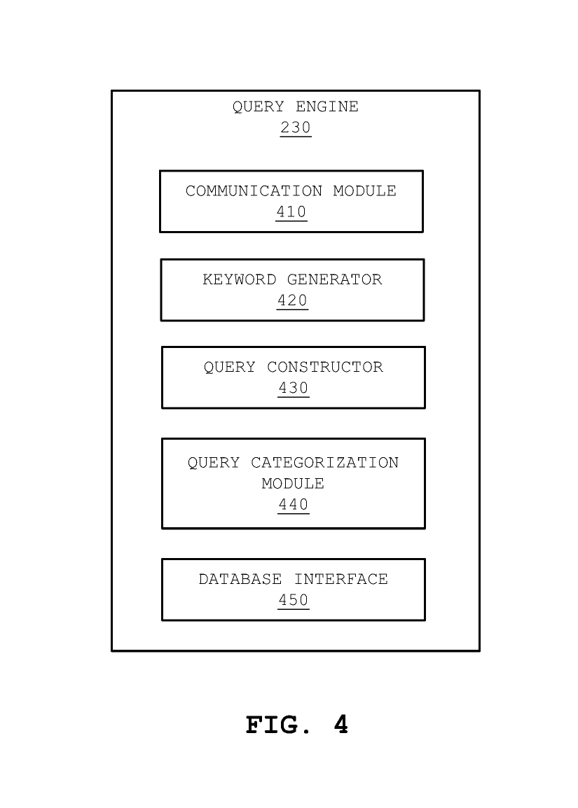

FIG. 4 is a block diagram illustrating an exemplary query engine 230, in accordance with one embodiment.

The query engine 230 includes a communication module 410, a keyword generator 420, a query constructor 430, a query categorization module 440 and a database interface 450. In one example, different components of the query engine 230 can communicate with each other through Application Programming Interfaces (APIs). In other embodiments, all or parts of the components can be implemented in hardware or benefit from special hardware accelerators.

The communication module 410 communicates with, for example, the computing device 210 (or an installed computer) to receive a question and send sets of user comments as answers to the question. The keyword generator 420 identifies important keywords and terms. In particular, the named entities and related entities are identified. The query constructor 430 constructs a query with the identified keywords and terms. The query categorization module 440 categorizes the query as either the information seeking query or the discussion oriented query. The database interface 450 establishes a pathway to query the database with the query to retrieve relevant sets of user comments as answers to the question.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standards 802.11, 802.11a, 802.11b, 802.11e, 802.11g, 802.11i, and 802.11n). In one example, signals from the computer can be transferred, at least in part, wirelessly to components or other computers.

Advantageously, a set of user comments is rendered to a question posted by a user. As a result, the user is provided with more relevant information and adequate user comments. Further, different websites engage the user more efficiently and allows the user to spend more time on the websites. This results in better revenue for the websites.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A computer-implemented method for providing sets of user comments as answers to a question, the computer-implemented method comprising:
receiving the question from a user, wherein the question comprises information posted by the user on a website;
constructing a query from the question;
analyzing the query;
extracting the sets of user comments related to the question from a database; and
rendering the sets of user comments to the user, wherein the sets of user comments are answers to the question.

2. The computer-implemented method of claim 1, wherein the sets of user comments are posted by one or more users on one or more websites.

3. The computer-implemented method of claim 1, wherein the constructing is based on contextual analysis and user preferences.

4. The computer-implemented method of claim 3, wherein the constructing comprises:
identifying a plurality of entities and correlated responses of the user.

5. The computer-implemented method of claim 4, wherein the plurality of entities comprises named entities and related entities.

6. The computer-implemented method of claim 1, wherein the analyzing comprises:
identifying the query as one of an information seeking query and a discussion oriented query; and
categorizing the query based on the identifying.

7. The computer-implemented method of claim 1, wherein the extracting comprises:
querying the database with the query.

8. The computer-implemented method of claim 1 and further comprising:
filtering the sets of user comments to render relevant answers to the user.

9. A computer program product stored on a non-transitory computer-readable medium that when executed by a processor, performs a method for providing sets of user comments as answers to a question, comprising:
receiving the question from a user, wherein the question includes information posted by the user on a website;
constructing a query from the question;
analyzing the query;
extracting the sets of user comments related to the question from a database; and
rendering the sets of user comments to the user, wherein the sets of user comments as answers to the question.

10. The computer program product of claim 9, wherein the plurality of sets of comments are posted by one or more users on one or more websites.

11. The computer program product of claim 9, wherein the constructing is based on contextual analysis and user preferences.

12. The computer program product of claim 11, wherein the constructing comprises:
identifying a plurality of entities and correlated responses of the user.

13. The computer program product of claim 12 wherein the plurality of entities includes named entities and related entities.

14. The computer program product of claim 9, wherein the analyzing comprises:
identifying the query as one of an information seeking query and a discussion oriented query; and
categorizing the query based on the identifying.

15. The computer program product of claim 9, wherein the extracting comprises:
querying the database with the query.

16. The computer program product of claim 9, further comprising:
filtering the sets of user comments to render relevant answers to the user.

17. A system for providing sets of user comments as answers to a question, the system comprising:
a web interface that receives the question posted by a user on a website;
a query engine that constructs a query from the question;
a database, communicatively coupled to the web interface, that stores one or more user comments posted on one or more websites; and
a retrieval engine that extracts the sets of user comments related to the question from the database.

18. The system of claim 17 and further comprising:
an analyzing module that identifies the query as one of an information seeking query and a discussion oriented query.

19. The system of claim 17, wherein the query engine comprises:
a query constructor that constructs the query from the question; and
a query categorization module that categorizes the query as one of the information seeking query and the discussion oriented query.

20. The system of claim 17, wherein the web interface renders the sets of user comments as answers to the question.
